(19) United States
(12) Patent Application Publication
(10) Pub. No.: US 2009/0319523 A1
(43) Pub. Date: Dec. 24, 2009

(54) Best Match Search

(75) Inventors: David R. Anderson, Chaska, MN (US); Jean Rawlings, Roy, UT (US); Jerry L. Mansfield, II, Shawnee, KS (US); Michael Mockus, Lawrence, KS (US); Ronald D. Myers, Alpine, UT (US)

Correspondence Address: FULBRIGHT & JAWORSKI L.L.P., 600 CONGRESS AVE., SUITE 2400, AUSTIN, TX, 78701, US

(73) Assignee: INGENIX, INC., Eden Prairie, MN (US)

(21) Appl. No.: 12/488,892

(22) Filed: Jun. 22, 2009

Related U.S. Application Data
(60) Provisional application No. 61/074,482, filed on Jun. 20, 2008.

(51) Int. Cl. G06F 17/30; G06F 15/16

(52) U.S. Cl. 707/6; 709/219; 707/E17.039

(57) ABSTRACT

An apparatus system and methods are presented for best match search. In one embodiment, the apparatus includes a plurality of functional modules configured to collect user profile information and a service provider criterion, match a service provider profile to at least one of the user profile information and the service provider criterion, calculate a service provider statistic based on service provider data associated with a selected service provider, and generate service provider comparison data in response to the service provider statistic. In the described embodiments, these modules include a profile collection module, a profile match module, a provider analyzer, and a provider comparison module.

### CROSS-REFERENCE TO RELATED APPLICATIONS

This application claims priority to U.S. Provisional Application No. 61/074,482 filed Jun. 20, 2008, the disclosure of which is incorporated herein by reference in its entirety.

### BACKGROUND OF THE INVENTION

1. Field of the Invention

The present invention relates generally to data analysis, and more particularly to an apparatus, system, and method for a best match search, where the search produces information associated with a service provider that best matches a users requirement.

2. Description of Related Art

Advances in the healthcare industry are increasing the number of treatments available for specific illnesses and ailments. A wider range of diseases can now be treated with specifically targeted treatments and procedures. Although this is a beneficial phenomenon from a patient treatment standpoint, this trend is increasing the volume of specialized knowledge that physicians are expected to master. Consequently, the healthcare industry is becoming increasingly specialized, physicians often specializing in only a certain area of the body or even in a specific disease or treatment. Although specialization trends are improving the quality of care available to patients suffering from particular conditions, it is becoming increasingly difficult for patients to locate specialists that are best suited to treat their specific condition.

A further level of complexity arises from current healthcare compensation schemes. Due to the potentially high cost of healthcare, many individuals obtain medical insurance coverage from a health insurance provider. To manage costs and quality of care for their customers, many health insurance providers have a group or network of approved healthcare providers. The level of coverage may vary depending on whether the health care provider is within the network or not. Consequently, patients not only have to search for the appropriate specialist, but also appropriate specialists that are within the health insurance group or network.

In response to these challenges, certain health insurance companies currently offer online directories of physicians that are covered within the health provider network. Common directories request a user to enter a zip code, and generate a list of physician's offices located within a predetermined radius of that zip code. Certain directories may allow a user to search for a physician by specialty, or by the type of procedure to be performed, but such directories provide little evaluative information upon which the patient may base his or her decision. Since many medical procedures are potentially life altering, many people desire additional information about the physician and his practice. Without additional information, it is difficult to make an informed decision on the most suitable physician for the particular patient.

These situations are not limited only to the health care industry. Most service industries are expanding in the United States, and consequently, the level of specialty of service providers is increasing. For example, it may be difficult for a person to locate a legal professional who has experience dealing with particular types legal matters or cases. For example, it may be desirable to locate an attorney who has particular experience dealing with tax issues involved in real estate development, or the like.

Other service industries may also face similar problems, such as accounting, real estate sales, architecture, engineering, and the like. In another example, a person who desires to sell their home may look for a real estate agent to help them list the home and to represent them during sale negotiations. Although the person may receive several offers for representation, it may be difficult to identify the agent that would provide the most optimal results (e.g., fastest sale, highest price, etc.). Currently there are only limited tools available to assist a consumer of services to locate the service provider most suited to help assist him or her in meeting his or her objectives.

The referenced shortcomings are not intended to be exhaustive, but rather are among many that tend to impair the effectiveness of previously known techniques in service provider directories; however, those mentioned here are sufficient to demonstrate that the methodologies appearing in the art have not been satisfactory and that a significant need exists for the techniques described and claimed in this disclosure.

### SUMMARY OF THE INVENTION

An apparatus system and methods are presented for best match search. In one embodiment, the apparatus includes a plurality of functional modules configured to collect user profile information and a service provider criterion, match a service provider profile to at least one of the user profile information and the service provider criterion, calculate a service provider statistic based on service provider data associated with a selected service provider, and generate service provider comparison data in response to the service provider statistic. In the described embodiments, these modules include a profile collection module, a profile match module, a provider analyzer, and a provider comparison module.

In one embodiment, the profile collection module includes a classifier collection module configured to collect a classifier to identify a specialty criterion for the service provider. The profile collection module may also include a user data collection module configured to collect the user profile information. In a specific embodiment, the user profile information includes a type of service required, a user characteristic, a physical location of the user, and a method of payment for the service. Additionally, the profile collection module may include a preference collection module configured to collect a preference identifier associated with one or more preferred characteristics in the service provider profile.

In one embodiment, the profile match module includes a criterion summary module configured to generate a summary of the user profile information and the service profile criterion for display to the user. In another embodiment, the criterion summary module is configured to generate a summary of the patient profile information and the professional service profile criterion for display to the user. The profile match module may also include a match results module configured to generate a display comprising one or more matching service provider profiles, wherein the one or more matching service provider profiles are generated in response to a search of a service provider database based on at least one of the user profile information and the service provider criterion. In a further embodiment, the profile match module has a sort module configured to sort a plurality of service provider profiles in response to a user selected sort criterion. Additionally, the profile match module may include a filter module configured to filter a plurality of service provider profiles in response to a user selected filter criterion.

The provider analyzer may include a query module. The query module may query a database of service records to identify one or more service records associated with the selected service provider. In a further embodiment, the service records may include medical insurance claim data associated with a claim for one or more medical services performed by a selected physician. The provider analyzer may also include a deidentifier module configured to remove personal information associated with a service record to ensure the privacy of a subject associated with the service record. Additionally, the provider analyzer may have a data processor configured to calculate the service provider statistic in response to data recorded in the one or more service records associated with the selected service provider. The provider analyzer may also include a provider scoring module configured to generate a score for the service provider in response to the service provider statistic, wherein the score is associated with a predetermined characteristics of the selected service provider.

In one embodiment, the provider comparison module includes a provider selector configured to receive a user input associated with a selection of the service provider profile. The provider comparison module may also include a provider biography module configured to generate a biographical profile associated the selected service provider. Additionally, the provider comparison module may have a provider service statistic module configured to format a service provider comparison chart, the service provider comparison chart further comprising the service provider statistic. In a further embodiment, the service provider statistic further is a service specific statistic associated with a selected service. In still a further embodiment, the service provider statistic further comprises a medication statistic associated with a record of a medication prescribed by a selected physician.

A system for best match search is also presented. In one embodiment, the system may include a data storage device, a server, and a network communication adapter. The data storage device may store a plurality of service records associated with a plurality of service providers. The server may collect user profile information and a service provider criterion, match a service provider profile to at least one of the user profile information and the service provider criterion, calculate a service provider statistic based on service provider data associated with a selected service provider, and generate service provider comparison data in response to the service provider statistic. The network communication adapter may communicate with a remote user over a network.

A method is also presented for best match search. In one embodiment, the method may include functional steps carried out by hardware components and modules described in relation to the apparatus and system. In a specific embodiment, the method may include collecting user profile information and a service provider criterion, matching a service provider profile to at least one of the user profile information and the service provider criterion, calculating a service provider statistic based on service provider data associated with a selected service provider, and generating service provider comparison data in response to the service provider statistic.

A computer readable medium comprising machine-readable instructions is also presented. The in a further embodiment, the computer readable medium may include computer readable code, including software code, firmware code, or machine code. Certain hardware components of the computer may read the computer readable instructions, store the computer readable instructions, and or configure hardware components to operationally carryout the instructions defined by the computer readable code contained on the computer readable medium. In a specific embodiment, the instructions may include collecting user profile information and a service provider criterion, matching a service provider profile to at least one of the user profile information and the service provider criterion, calculating a service provider statistic based on service provider data associated with a selected service provider, and generating service provider comparison data in response to the service provider statistic.

The term “coupled” is defined as connected, although not necessarily directly, and not necessarily mechanically.

The terms “a” and “an” are defined as one or more unless this disclosure explicitly requires otherwise.

The term “substantially” and its variations are defined as being largely but not necessarily wholly what is specified as understood by one of ordinary skill in the art, and in one non-limiting embodiment “substantially” refers to ranges within 10%, preferably within 5%, more preferably within 1%, and most preferably within 0.5% of what is specified.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

Other features and associated advantages will become apparent with reference to the following detailed description of specific embodiments in connection with the accompanying drawings.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is schematic block diagram illustrating one embodiment of a system for best match search;

FIG. 2 is a schematic block diagram illustrating an example of a processing apparatus;

FIG. 3 is schematic block diagram illustrating one embodiment of an apparatus for best match search;

FIG. 4 is detailed schematic block diagram illustrating one embodiment of an apparatus for best match search;

FIG. 5 is schematic flowchart diagram illustrating one embodiment of a method for best match search;

FIG. 6 is a screen-shot diagram illustrating one embodiment of a graphical user interface for user profile collection;

FIG. 7 is a screen-shot diagram illustrating one embodiment of a graphical user interface for presenting a matching service provider profile;

FIG. 8 is a screen-shot diagram illustrating one embodiment of a graphical user interface for comparing a plurality of service provider profiles;

FIG. 9 is a screen-shot diagram illustrating a further embodiment of a graphical user interface for comparing a plurality of service provider profiles;

FIG. 10 is a screen-shot diagram illustrating one embodiment of a graphical user interface for presenting profile information for a selected service provider;

FIG. 11 is a screen-shot diagram illustrating a further embodiment of a graphical user interface for presenting profile information for a selected service provider;

FIG. 12 is a screen-shot diagram illustrating yet a further embodiment of a graphical user interface for presenting profile information for a selected service provider;

FIG. 13 is a conceptual diagram illustrating one embodiment of a concept for a system for best match search;

FIG. 14 is a schematic block diagram illustrating an example of a representative embodiment of a system for best match search;

FIG. 15 is a schematic block diagram illustrating an example of a representative embodiment of a web application module for best match search;

FIG. 16 is a schematic block diagram illustrating an example of a representative embodiment of a web service for best match search;

FIG. 17 is a schematic block diagram illustrating an example of a representative embodiment of an Internet accessible web application for best match search;

FIG. 18 is a schematic flowchart diagram illustrating an example of a representative embodiment of a method for presenting a dynamically updating service provider counter;

FIG. 19 is a schematic flowchart diagram illustrating an example of a representative embodiment of a method for generating a list of service providers that match user profile information and/or service provider criterion;

FIG. 20 is a schematic flowchart diagram illustrating an example of a further embodiment of a method for presenting a dynamically updating service provider counter;

FIG. 21 is a schematic flowchart diagram illustrating an example of a further embodiment of a method for generating a list of service providers that match user profile information and/or service provider criterion;

FIG. 22 is a schematic block diagram illustrating an example of a representative embodiment of an apparatus for best match search;

FIG. 23 is a schematic block diagram illustrating an example of a representative embodiment of a system for providing a web based best match search application;

FIG. 24 is a conceptual diagram illustrating an example of a representative embodiment of a method for providing a web service for best match search;

FIG. 25 is a conceptual diagram illustrating an example of a representative embodiment of a method for providing network access to web based application for best match search;

FIG. 26 is a schematic flowchart diagram illustrating an example of transactions within a system for best match search;

FIG. 27 is a schematic block diagram illustrating an example of a further embodiment of a tiered system for best match search.

### DESCRIPTION OF ILLUSTRATIVE EMBODIMENTS

The apparatus, system and methods described in the various embodiments resolve the long felt, but unresolved need for providing comparative analytical information to a consumer of services based on information regarding the service provider's prior experience and practice. This need was previously unmet because it is difficult to identify appropriate data from which to generate the analytical information, and because it was difficult to generate useable analytical information if the appropriate data was identified. For example, insurance claim data may be an appropriate data source for information regarding an physicians practice. However, there were previously several obstacles to using insurance claim data to provide usable analytical information to a potential customer including, but not limited to: (1) the volume of the data available is difficult to adequately process, (2) the data includes personal and private details associated with individuals receiving the treatment, (3) it is difficult to match the raw insurance claim data with the requirements of the potential customer. There may have been additional obstacles not mentioned in this disclosure. The present embodiments resolve these, and other, previously unmet needs.

Various features and advantageous details are explained more fully with reference to the nonlimiting embodiments that are illustrated in the accompanying drawings and detailed in the following description. Descriptions of well known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure.

Certain units described in this specification have been labeled as modules, in order to more particularly emphasize their implementation independence. A module is “[a] self-contained hardware or software component that interacts with a larger system.” Alan Freedman, “The Computer Glossary” 268 (8th ed. 1998). A module comprises a machine or machines suitably programmed to operate according to executable instructions. For example, a module may be implemented as a hardware circuit comprising custom VLSI circuits or gate arrays, off-the-shelf semiconductors such as logic chips, transistors, or other discrete components. A module may also be implemented in programmable hardware devices such as processors, microprocessors, field programmable gate arrays, programmable array logic, programmable logic devices or the like.

Modules may also include software-defined units or instructions, that when executed by a processing machine or device, transform data stored on a data storage device from a first state to a second state. An identified module of executable code may, for instance, comprise one or more physical or logical blocks of computer instructions which may be organized as an object, procedure, or function. Nevertheless, the executables of an identified module need not be physically located together, but may comprise disparate instructions stored in different locations which, when joined logically together, comprise the module, and when executed by the processor, achieve the stated data transformation.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices.

In the following description, numerous specific details are provided, such as examples of programming, software modules, user selections, network transactions, database queries, database structures, hardware modules, hardware circuits, hardware chips, etc., to provide a thorough understanding of the present embodiments. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

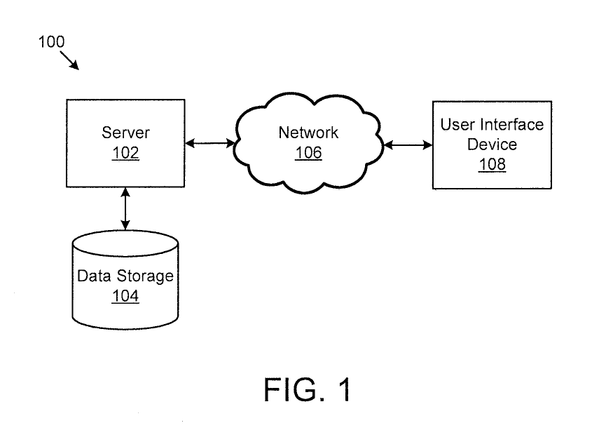

FIG. 1 illustrates one embodiment of a system 100 for best match search. The system 100 may include a server 102 a data storage device 104, a network 106, and a user interface device 108. In a general embodiment, the system 100 may facilitate providing a best possible patch between a service provider and a potential service consumer. The system 100 may provide the consumer with detailed information regarding one or more potentially matching service providers, so that the service consumer can make an informed decision when selecting a service provider.

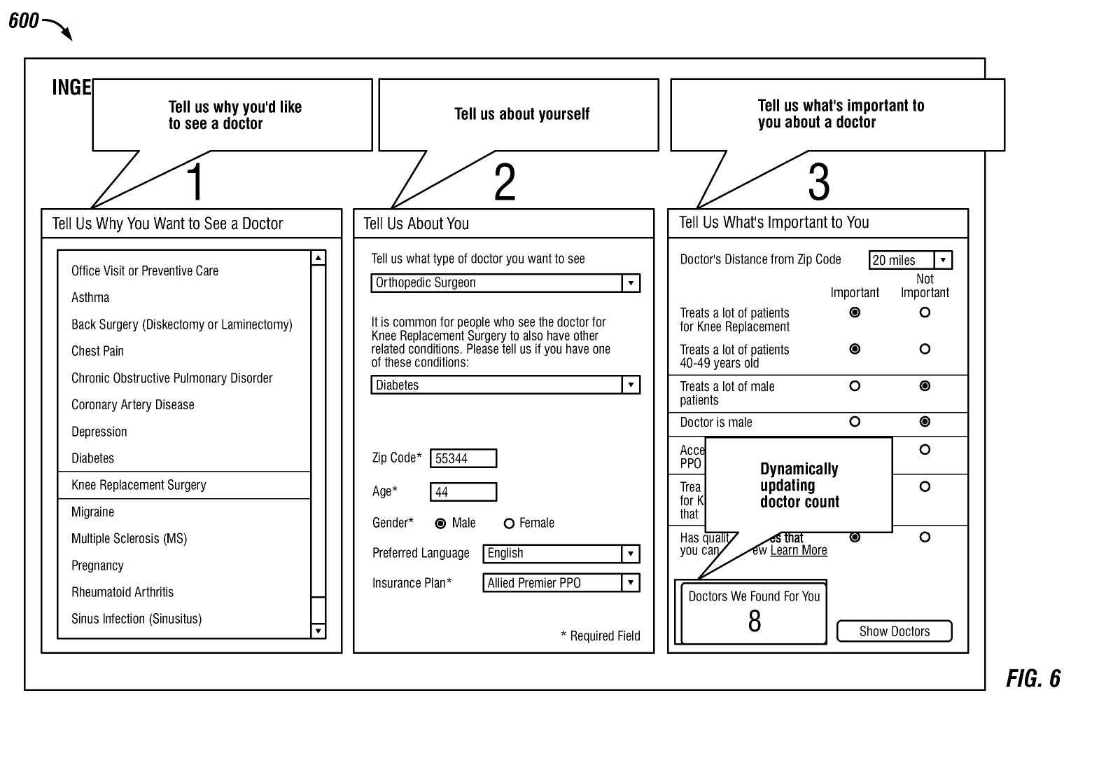

In one embodiment, the user interface device 108 is referred to broadly and is intended to encompass any suitable processor-based device such as a desktop computer, a laptop computer, a Personal Digital Assistant (PDA), a mobile communication device or organizer device having access to the network 106. In a further embodiment, the user interface device 108 may access the Internet to access a web application or web service hosted by the server 102 and provide a user interface for enabling the service consumer (user) to enter user profile information and/or service provider criterion. For example, the user may enter a particular type of service for which he is seeking a provider. In a further embodiment, the user may enter a user characteristic, such as preexisting conditions, a physical location of the user, and a method of payment intended for the service. Specific examples of the types of user profile information and service provider criterion that the user may enter are illustrated in FIG. 6 and described below with reference to that figure.

The network 106 may facilitate communications of data between the server 102 and the user interface device 108. The network 106 may include any type of communications network including, but not limited to a direct PC to PC connection, a local area network (LAN), a wide area network (WAN), a modem to modem connection, the Internet, a combination of the above, or any other communications network now known or later developed within the networking arts which permits two or more computers to communicate with each other.

In one embodiment, the server 102 is configured to collect user profile information and a service provider criterion. Specifically, the server 102 may receive the criterion from an application user interface accessed over the network 106 by the user interface device 108. The server 102 may also match a service provider profile to at least one of the user profile information and the service provider criterion. Additionally, the server 102 may calculate a service provider statistic based on service provider data associated with a selected service provider. In a further embodiment, the server 102 may generate service provider comparison data in response to the service provider statistic. In various embodiments, the server 102 may accomplish these tasks using software defined hardware modules, wherein the software is stored on a computer readable or machine-readable medium. Additionally, the server may access data stored in the data storage device 104 via a Storage Area Network (SAN) connection, a LAN, a data bus, or the like.

The data storage device 104 may include a hard disk, including hard disks arranged in an Redundant Array of Independent Disks (RAID) array, a tape storage drive comprising a plurality of magnetic tape data storage devices, or the like. In one embodiment, the data storage device 104 may store a plurality of service records associated with a plurality of service providers. The service records may be arranged in a database and accessible through Structured Query Language (SQL) queries, or other data base query operations.

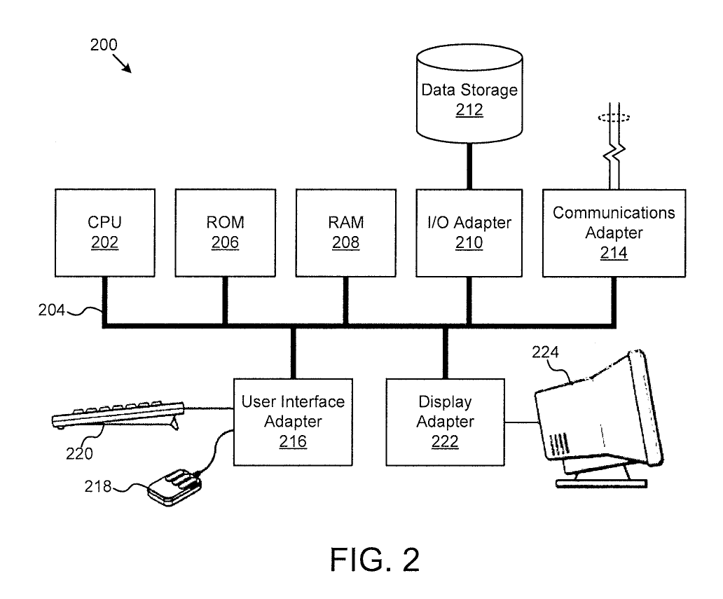

FIG. 2 illustrates a computer system 200 adapted according to certain embodiments of the server 102 and/or the user interface device 108. The central processing unit (CPU) 202 is coupled to system bus 1002. The CPU 202 may be any general purpose CPU. The present embodiments are not restricted by the architecture of the CPU 202 as long as the CPU 202 supports the modules and operations as described herein. The CPU 202 may execute the various logical instructions according to embodiments of the present invention. For example, the CPU 202 may execute machine-level instructions according to the exemplary operational flows described above in conjunction with below.

The computer system 200 also may include Random Access Memory (RAM) 208, which may be SRAM, DRAM, SDRAM, or the like. The computer system 200 may utilize RAM 208 to store the various data structures used by a software application configured to perform best match search. The computer system 200 may also include Read Only Memory (ROM) 206 which may be PROM, EPROM, EEPROM, or the like. The ROM may store configuration information for booting the computer system 200. The RAM 208 and the ROM 206 hold user and system 100 data.

The computer system 200 may also include an input/output (I/O) adapter 210, a communications adapter 214, a user interface adapter 216, and a display adapter 222. The I/O adapter 210 and/or user the interface adapter 216 may, in certain embodiments, enable a user to interact with the computer system 200 in order to input information for user profile information and service provider criterion, such as entering a specialty required, a treatment required, a gender of the doctor, a physical location of the user, and the like. In a further embodiment, the display adapter 222 may display a graphical user interface associated with a software or web-based application for best match search.

The I/O adapter 210 may connect to one or more storage devices 212, such as one or more of a hard drive, a Compact Disk (CD) drive, a floppy disk drive, a tape drive, to the computer system 200. The communications adapter 214 may be adapted to couple the computer system 200 to the network 106, which may be one or more of a LAN and/or WAN, and/or the Internet. The user interface adapter 216 couples user input devices, such as a keyboard 220 and a pointing device 218, to the computer system 200. The display adapter 222 may be driven by the CPU 202 to control the display on the display device 224.

The present embodiments are not limited to the architecture of system 200. Rather the computer system 200 is offered as an example of one type of computing device that may be adapted to perform the functions of either the server 102 or the user interface device 108. For example, any suitable processor-based device may be utilized including without limitation personal data assistants (PDAs), computer game consoles, and multi-processor servers. Moreover, embodiments of the present invention may be implemented on application specific integrated circuits (ASIC) or very large scale integrated (VLSI) circuits. In fact, persons of ordinary skill in the art may utilize any number of suitable structures capable of executing logical operations according to the embodiments of the described embodiments.

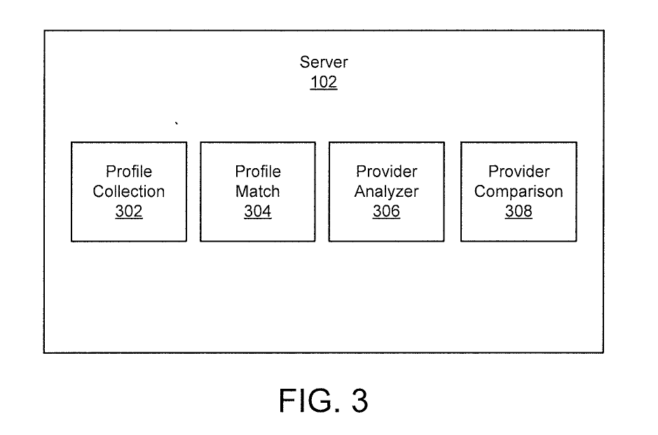

FIG. 3 illustrates a further embodiment of the server 102. In the depicted embodiment, the server 102 may include a profile collection module 302, a profile match module 304, a provider analyzer 306, and a provider comparison module 308.

The profile collection module 302 may collect user profile information and a service provider criterion. For example, as described above, profile collection module 302 may receive the user profile information and/or the service provider criterion from the user via the communications adapter 214 which may be connected to the user interface device 108 over the Internet 106. In the embodiment described in FIG. 6, the user profile information may include a reason to see a physician, a specialty of physician required, a preexisting condition, a zip code of the user, an age of the user, a gender of the user, a preferred language of the user, and the insurance plan to which the user intends to submit a claim for payment. The service provider criterion may include a distance from the user's physical location, and certain other criterion such as the gender of the physician, the age of the physician, the source of education of the physician, etc. These examples of user profile information and service provider criterion are provided by way of example only, and are not intended to represent limiting or exhaustive lists. One may recognize other suitable profile information or service provider criterion which may be suitable for matching service providers with consumers of other types of services such as legal services, real estate services, and the like.

The profile match module 304 may communicate with the profile connection module 302 over a data communication coupling (not shown). The profile match module 304 may match a service provider profile with the user profile information and/or the service provider criterion. For example, the profile match module 304 may submit an SQL query to the data storage device 104. The query may include certain search terms defined by entries in the user profile information and/or the service provider criterion. The a database server (not shown) may then search entries in the database keyed on the search terms to identify one or more service providers that match the search requirements. The profile match module 304 may then retrieve a service provider profile for each of the service providers returned by the SQL, query. Alternatively, the query may return the service provider profiles automatically.

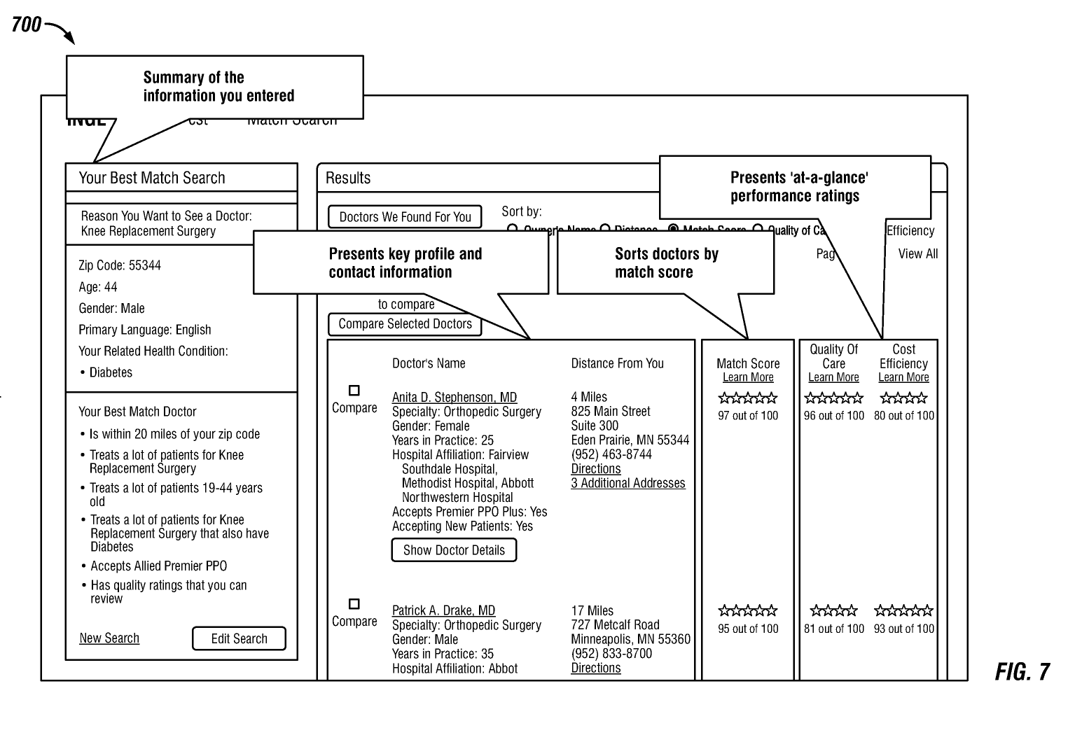

The provider analyzer 306 may communicate with the profile match module 304 over a data coupling. The provider analyzer 306 may calculate a service provider statistic based on service provider data associated with a selected service provider. For example, the profile match module 304 may return a list of service provider profiles as illustrated in FIG. 7. The user may then select one or more service providers to compare. Selection data is then passed to the provider analyzer 306. The provider analyzer 306 may then retrieve data associated with selected service provider from the data storage device 104 and calculate statistics based on trends in the data. In one specific embodiment, the provider analyzer 306 may retrieve insurance claims data associated with a physician using an SQL query of a database of insurance claim data. The provider analyzer 306 may then calculate certain statistics, such as the number of patients suffering from a specified illness the physician has treated.

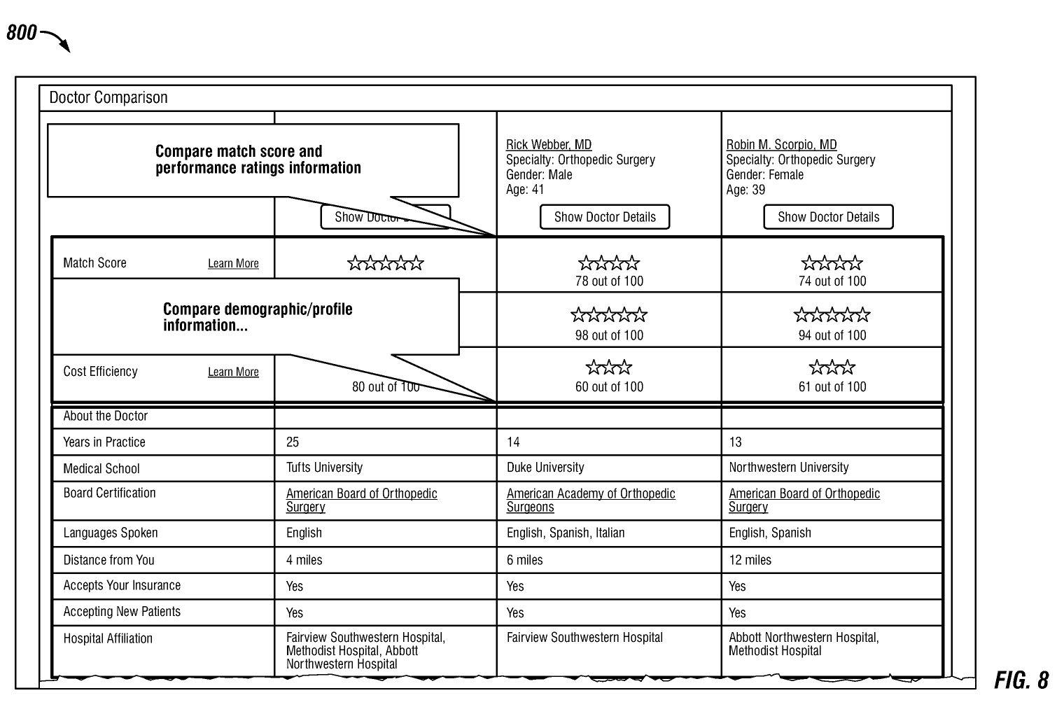

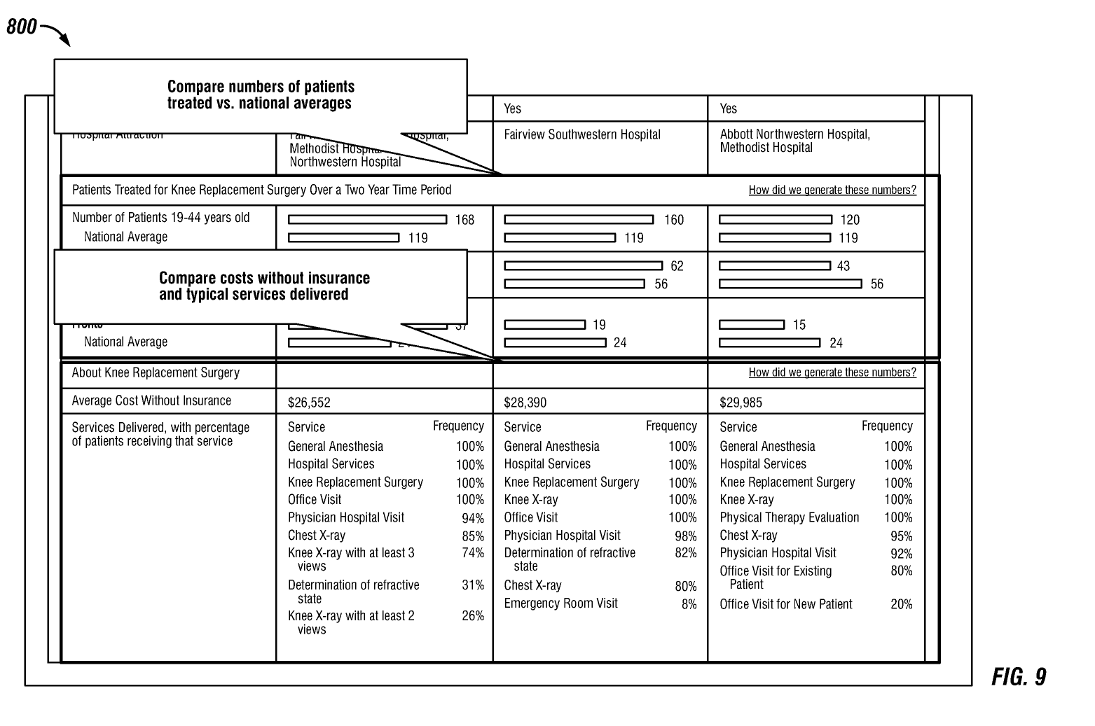

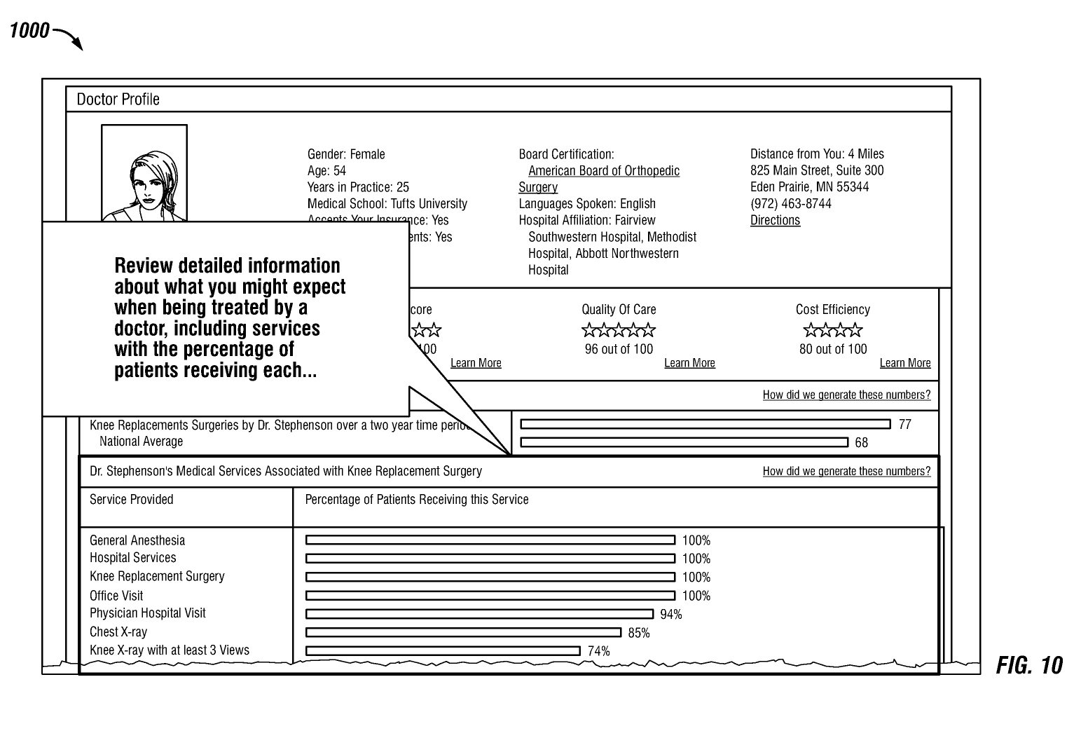

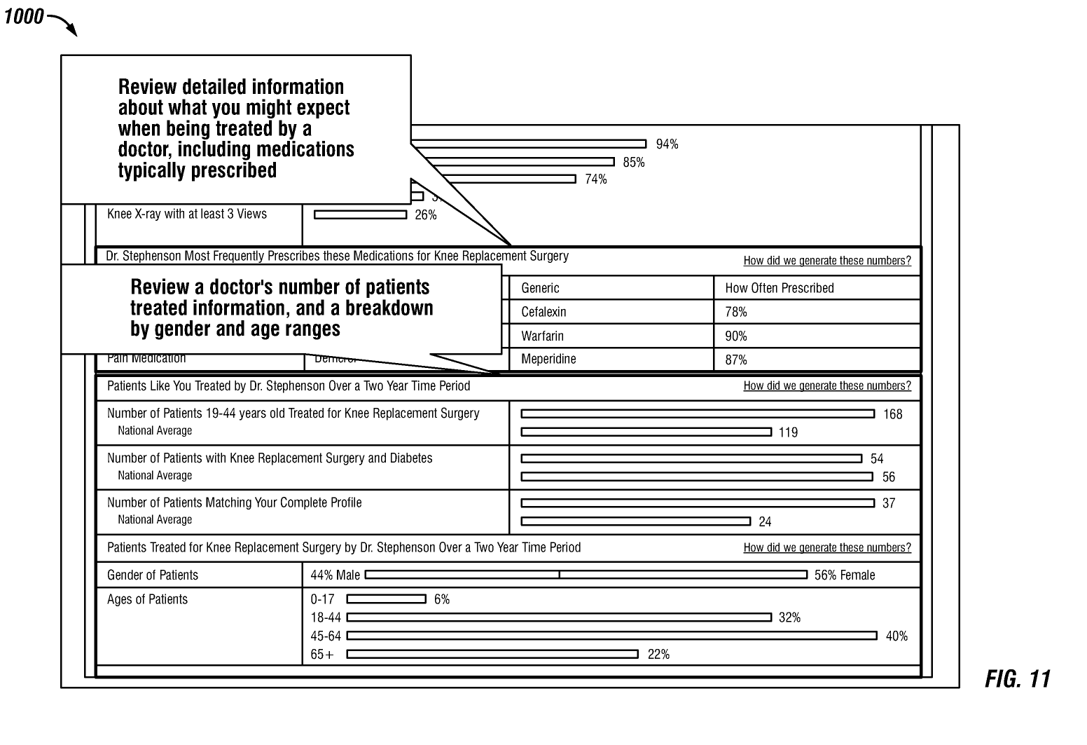

The provider comparison module 308 may be coupled to the provider analyzer 306 by a data coupling. The provider comparison module 308 may generate service provider comparison data in response to the service provider statistic. For example, the provider comparison module 308 may generate a service provider comparison chart as illustrated in FIGS. 8-9. Additionally, the provider comparison module 308 may provide additional data for each selected service provider as illustrated in FIGS. 10-12. Of course alternative embodiments may exist, especially when the modules are applied to searching for providers of services other than healthcare services.

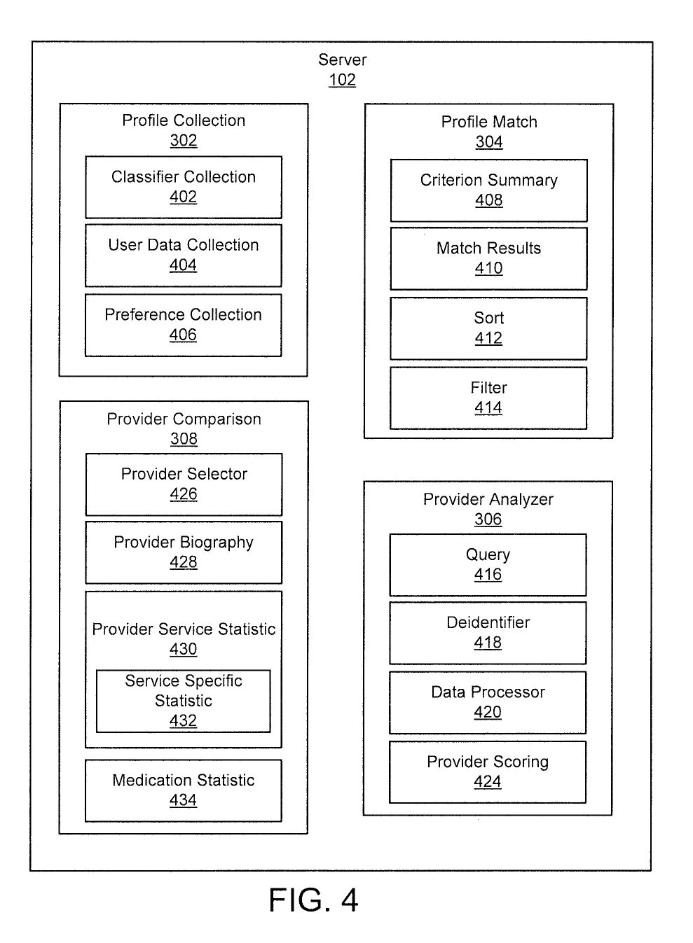

FIG. 4 is a further embodiment of the server 102. The embodiment illustrated in FIG. 4 may include the profile collection module 302, the profile match module 304 the provider analyzer 306, and the provider comparison module 308 substantially as described above with relation to FIG. 3. However, each module 302-308 may include additional modules configured to perform additional functions.

In one embodiment, the profile collection module 302 includes a classifier collection module 402 configured to collect a classifier to identify a specialty criterion for the service provider. The profile collection module 302 may also include a user data collection module 404 configured to collect the user profile information. In a specific embodiment, the user profile information includes a type of service required, a user characteristic, a physical location of the user, and a method of payment for the service. Additionally, the profile collection module 302 may include a preference collection module 406 configured to collect a preference identifier associated with one or more preferred characteristics in the service provider profile. Examples of a graphical user interface associated with these various modules 402-406 is illustrated in FIG. 6.

In one embodiment, the profile match module 304 includes a criterion summary module 408 configured to generate a summary of the user profile information and the service profile criterion for display to the user. In another embodiment, the criterion summary module 408 is configured to generate a summary of the patient profile information and the professional service profile criterion for display to the user. One example of the criterion summary is illustrated in FIG. 7. The profile match module 304 may also include a match results module 410 configured to generate a display comprising one or more matching service provider profiles, wherein the one or more matching service provider profiles are generated in response to a search of a service provider database based on at least one of the user profile information and the service provider criterion. As illustrated in FIG. 7, the display may include biographical information related with the service provider, one or more scores for the service provider based on analysis or feedback of quality of service and cost, and one or more selectable operators for allowing the user to select a service provider profile. In a further embodiment, the profile match module 304 has a sort module 412 configured to sort a plurality of service provider profiles in response to a user selected sort criterion. Additionally, the profile match module 304 may include a filter module 414 configured to filter a plurality of service provider profiles in response to a user selected filter criterion.

The provider analyzer 306 may include a query module 416. The query module 416 may query a database of service records to identify one or more service records associated with the selected service provider. As described above, the database may be stored on the data storage device 104. In a further embodiment, the service records may include medical insurance claim data associated with a claim for one or more medical services performed by a selected physician. The provider analyzer 306 may also include a deidentifier module 418 configured to remove personal information associated with a service record to ensure the privacy of a subject associated with the service record. Additionally, the provider analyzer 306 may have a data processor 420 configured to calculate the service provider statistic in response to data recorded in the one or more service records associated with the selected service provider. The provider analyzer 306 may also include a provider scoring module 424 configured to generate a score for the service provider in response to the service provider statistic, wherein the score is associated with a predetermined characteristics of the selected service provider. An example of the score that the provider scoring module 424 may generate is illustrated in FIGS. 7-8 and 10.

In one embodiment, the provider comparison module 308 includes a provider selector 426 configured to receive a user input associated with a selection of the service provider profile. In an alternative embodiment, this module may be incorporated with the profile match module 304. The provider comparison module 308 may also include a provider biography module 428 configured to generate a biographical profile associated the selected service provider. Examples of the biographical profile can be found in FIG. 7-12. Additionally, the provider comparison module 308 may have a provider service statistic module 430 configured to format a service provider comparison chart, the service provider comparison chart further comprising the service provider statistic. An example of the service provider comparison chart is illustrated in FIGS. 8-9, and further user provider statistics may be formatted by the provider service statistic module 430 into a detailed service report illustrated in FIGS. 10-12. In a further embodiment, the service provider statistic further is a service specific statistic associated with a selected service. For example the number of times an orthopedic surgeon has performed a knee replacement surgery. In still a further embodiment, the service provider statistic may include a medication statistic associated with a record of a medication prescribed by a selected physician.

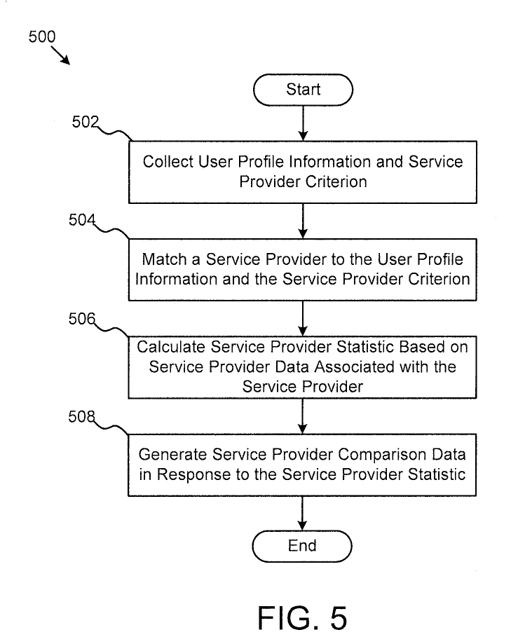

FIG. 5 is one embodiment of a method 500 for best match search. In one embodiment, the method 500 starts when the profile collection module 302 collects 502 user profile information and/or a service provider criterion from the user. The user may enter the user profile information or the service provider criterion using a web-based graphical user interface, and submit the information over the Internet to the server 102.

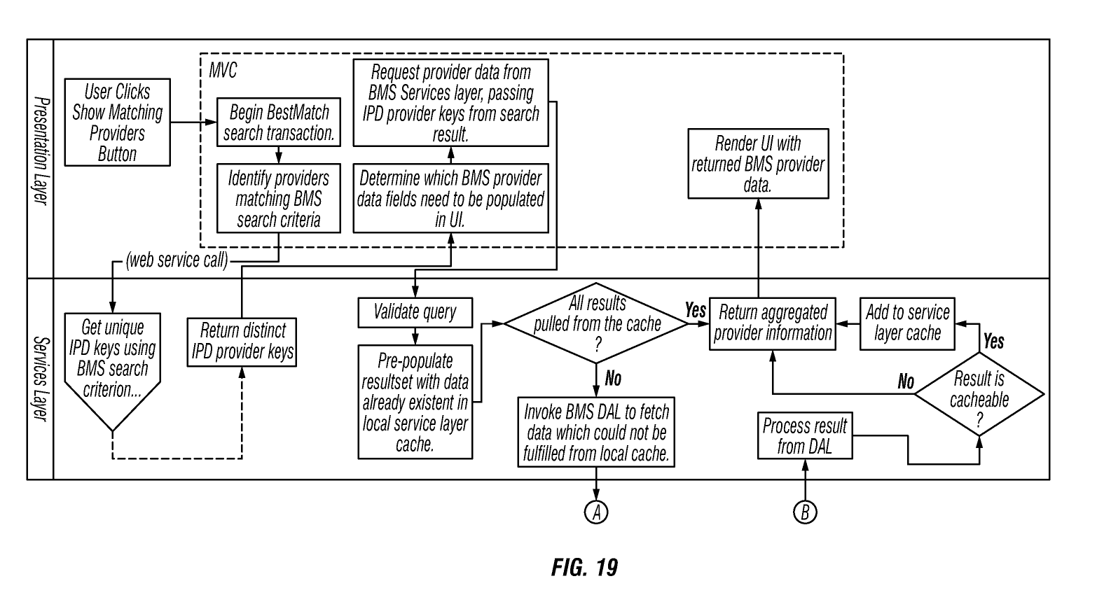

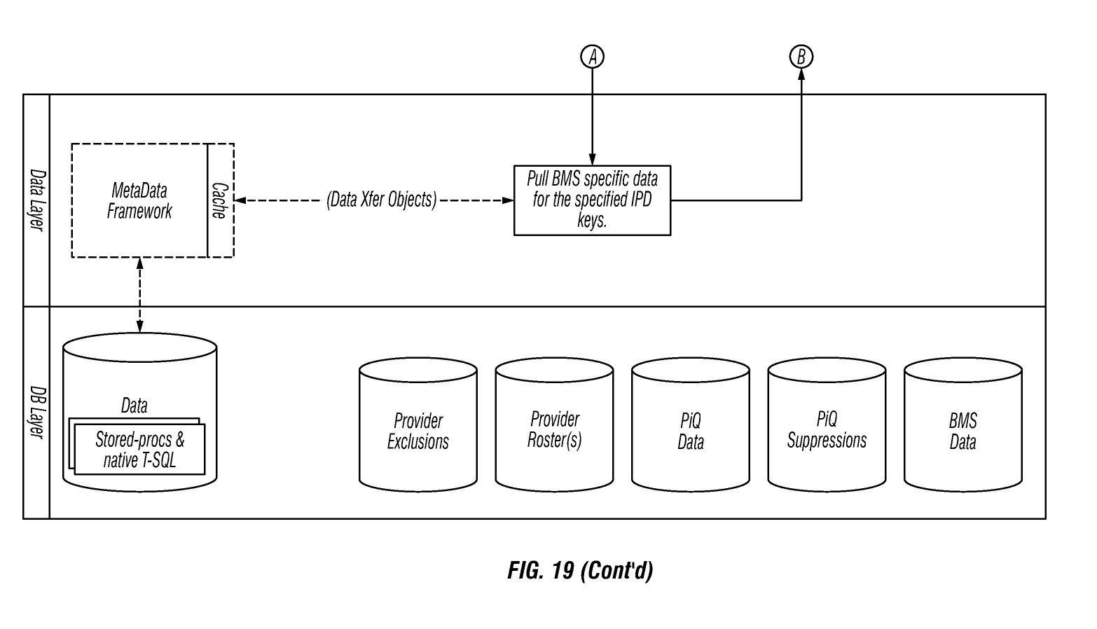

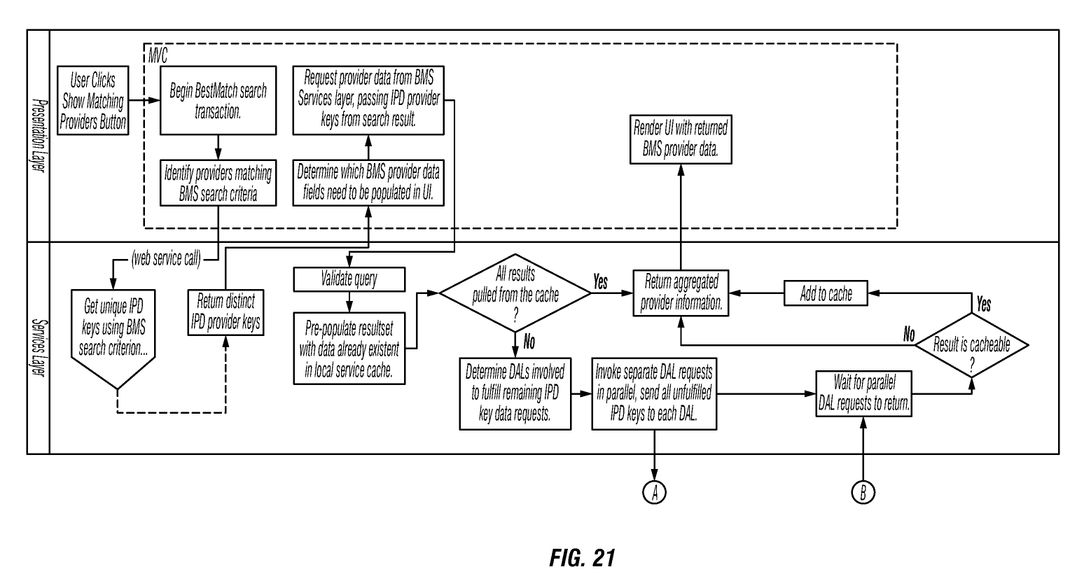

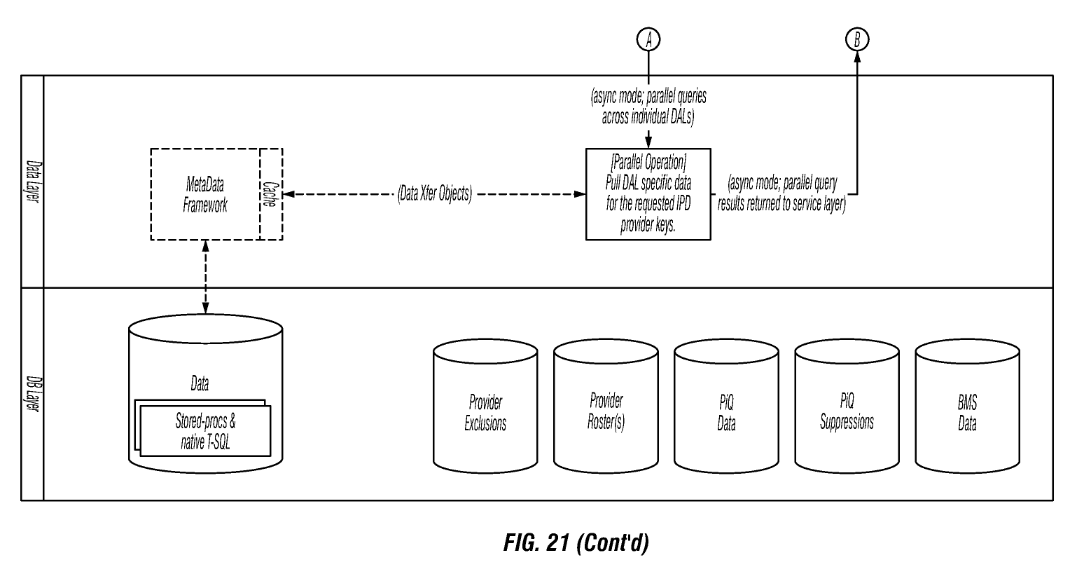

The profile match module 304 may then match 504 a service provider to the user profile information and the service provider criterion. Further embodiments of methods for generating a list of service providers that match user profile information and/or service provider criterion are illustrated in FIGS. 19 and 21. In response to a user selection, the provider analyzer 306 may calculate 506 a service provider statistic based on service provider data associated with the service provider. For example, the service provider data associated with an attorney may include cases litigated or transactional matters handled by the attorney.

Finally, the provider comparison module 308 may generate 508 service provider comparison data and format the provider comparison data into a comparison chart. In a further embodiment, the user may then select a service provider and the comparison module 308 may display a detailed report listing several statistics associated with the service provider as well as biographical data associated with the service provider. In still a further embodiment, a map and driving directions to the office of the service provider may be presented.

Various further and/or alternative embodiments of the method may described implicitly in the figures, description, and computer code described herein. One of ordinary skill in the art will recognize these various embodiments, as well as how to implement these various embodiments without undue experimentation. Therefore, the detailed description of the interactions between the modules described herein with reference to every possible embodiment is not required.

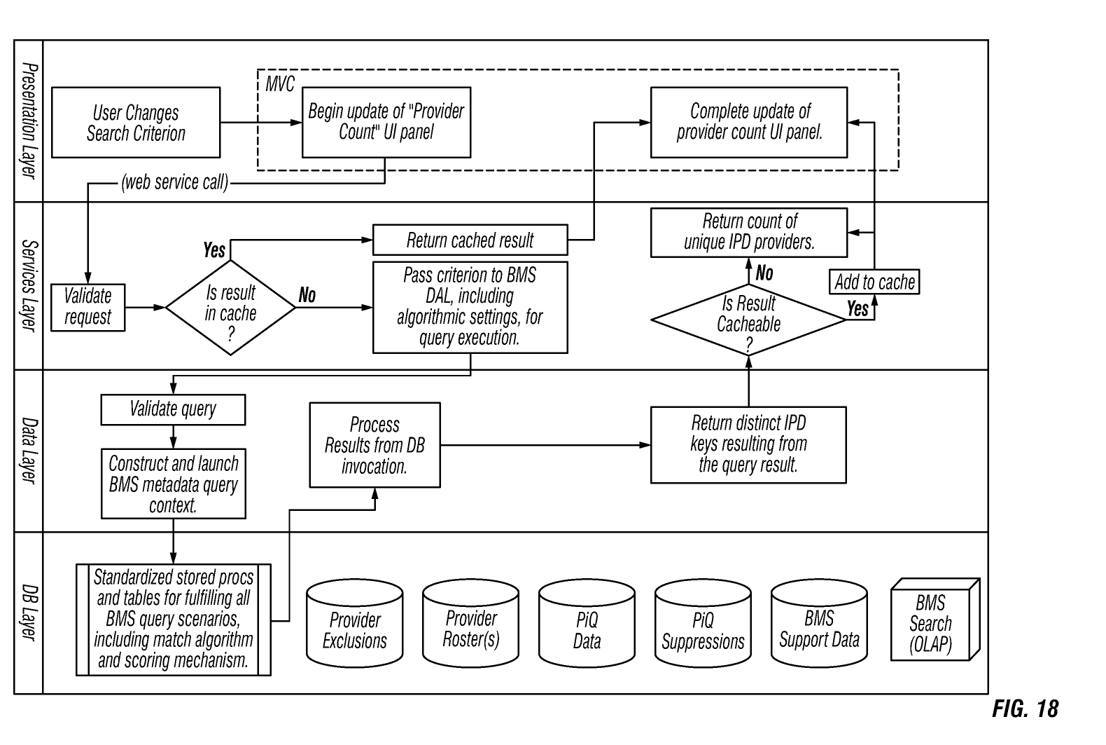

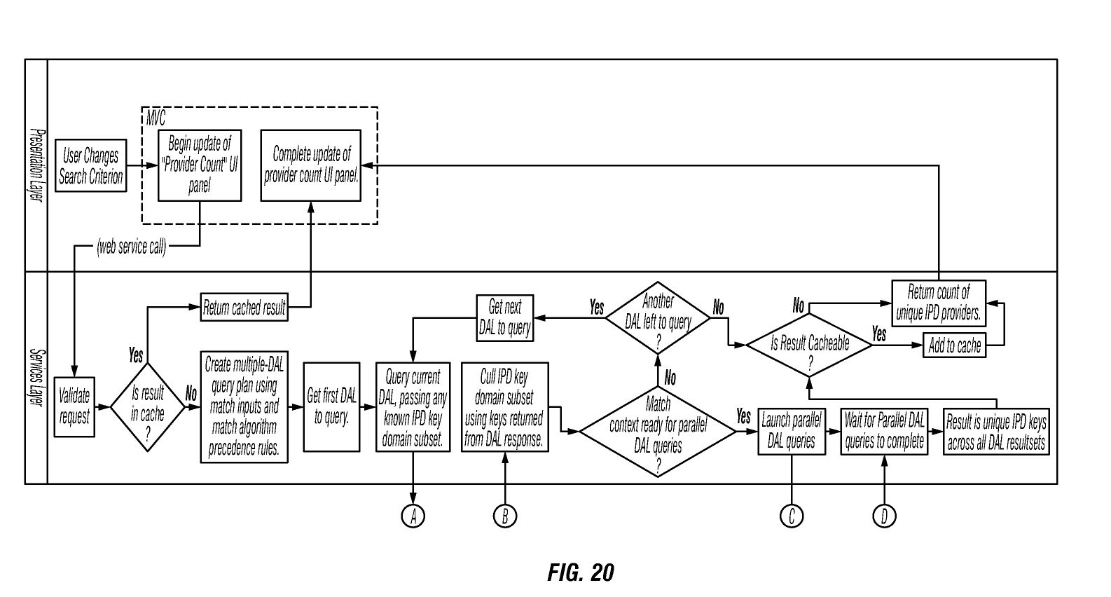

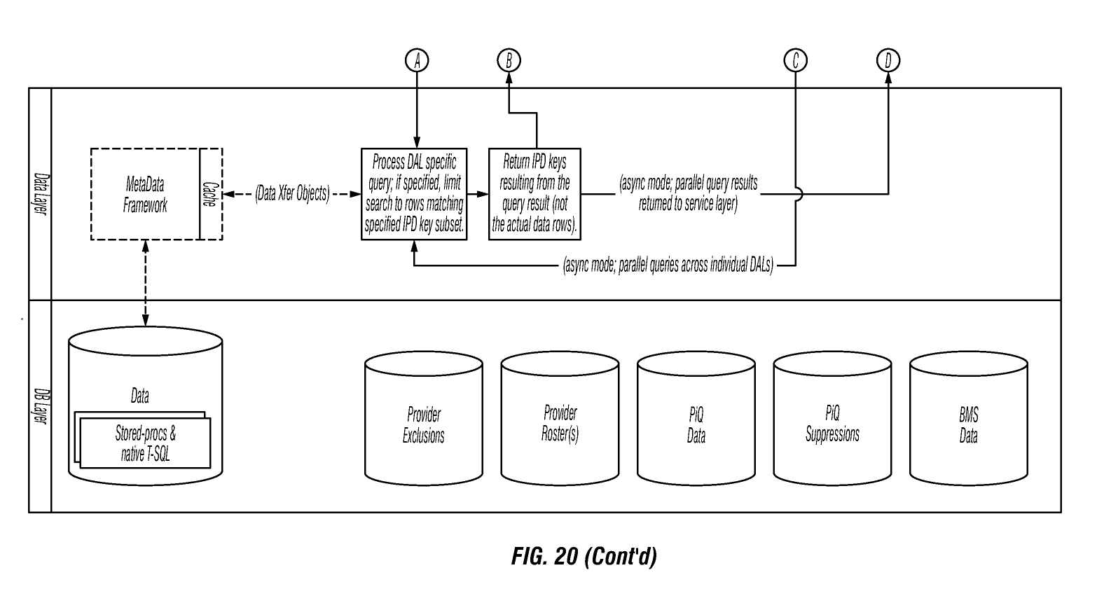

FIG. 6 illustrates a graphical user interface 600 that may be associated with the profile collection module 302. In one embodiment, the profile collection module 302 may generate and communicate the graphical user interface 600 over the Internet 106 to the user interface device 108. The embodiment of FIG. 6 may include three dynamically updating panels (shown but not labeled). In a further embodiment, the graphical user interface 600 may include a dynamically updating counter to show a number of service providers that have been identified as matches to the user profile information and/or service provider criterion entered. Further embodiments of methods and software configurations for generating the dynamically updating counter are illustrated in FIGS. 18 and 20. In the depicted embodiment, the user profile information may be entered into panels 1 and 2 and the service provider criterion may be entered into panel 3.

FIG. 7 illustrates one embodiment of a service provider selection list 700 that may be generated by the provider match module 304. The user may select one or more service providers using a selectable operator such as a checkbox or radio button. The depicted embodiment may also include a criterion summary field so that the user may reference his/her selections in the graphical user interface 600 of FIG. 6 when determine which service providers in the list 700 to select. Additionally, the list 700 may include biographical information, and score information associated with the service providers.

FIGS. 8-9 illustrate one embodiment of a service provider comparison chart 800 which may be generated by the provider comparison module 308. As illustrated the service provider comparison chart may include a side-by-side list of service provider profile data associated with one or more service providers selected for the comparison. The comparison chart may include ratings or scores, biographical information, or as illustrated in FIG. 9, statistics associated with the service provider's practice and prior performance of the services requested.

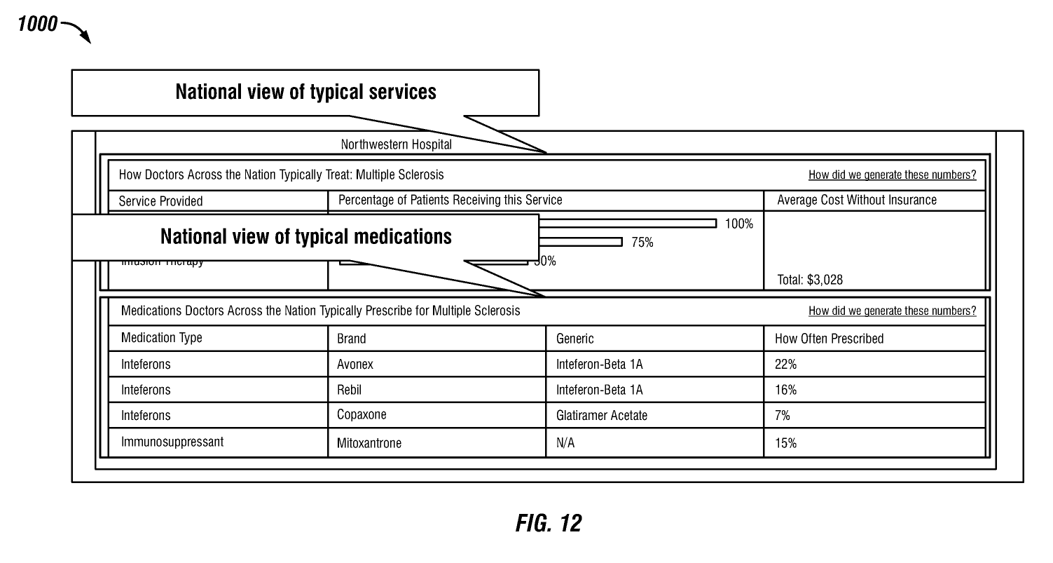

FIGS. 10-12 illustrate one embodiment of a detailed report 1000 formatted from statistics generated by the provider analyzer 306. The detailed report 1000 may include further statistics or details with regard to the services the service provider has performed. In the embodiment depicted in FIG. 12, the detailed report 1000 may even include the types of medications a physician has prescribed.

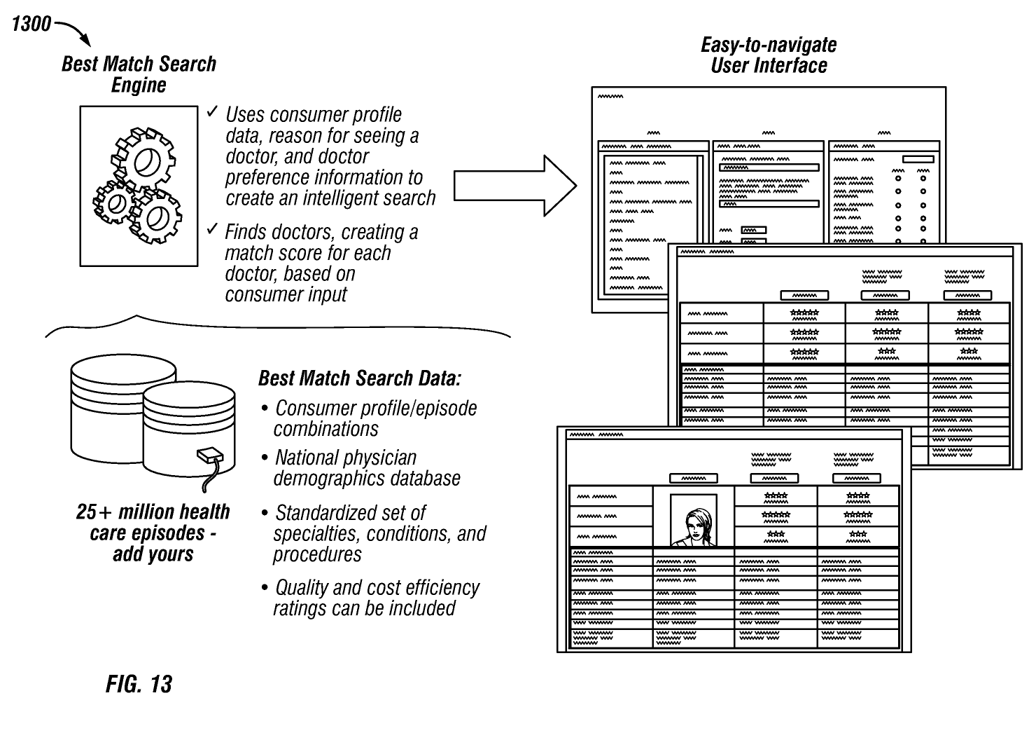

FIG. 13 is a conceptual diagram illustrating a summary of the overall process of the present embodiments. First the best match search engine, which may be implemented as the module of FIGS. 2-4, may generate one or more graphical user interfaces 600 for receiving user profile information, the service provider criterion, and user selections. The graphical user interfaces may also present comparison charts 800 and detailed reports 1000. The best match search engine may further access best match search data stored in a data storage device 104.

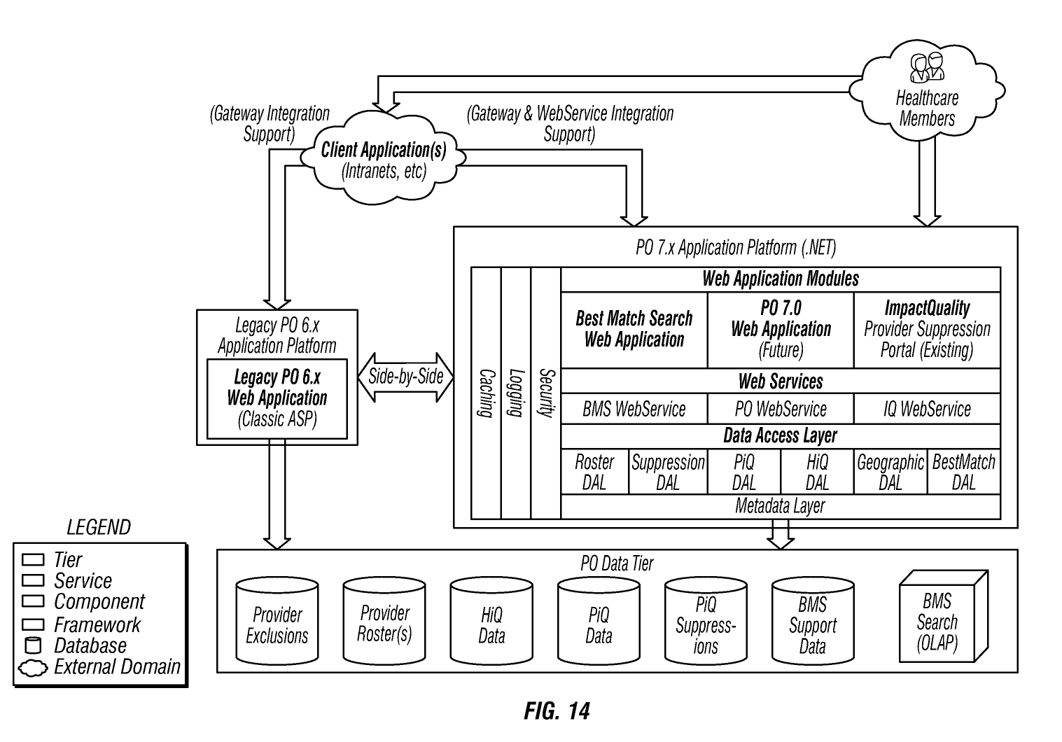

FIG. 14 is a schematic block diagram illustrating an example of a representative embodiment of a system for best match search. This example may be implemented to provide a best match search for a physician, hospital, or healthcare provider. The depicted embodiment further illustrates how one might implement the present embodiments on an existing server 102 or in currently available infrastructure. The system of FIG. 14 illustrates a hardware implementation of the present embodiments.

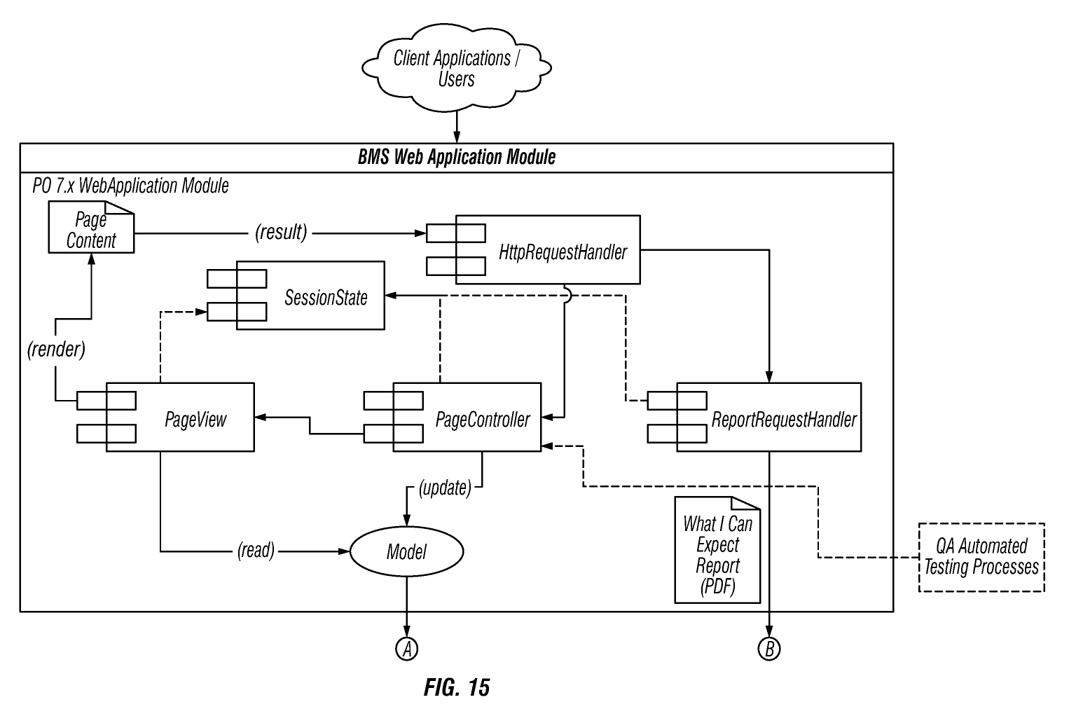

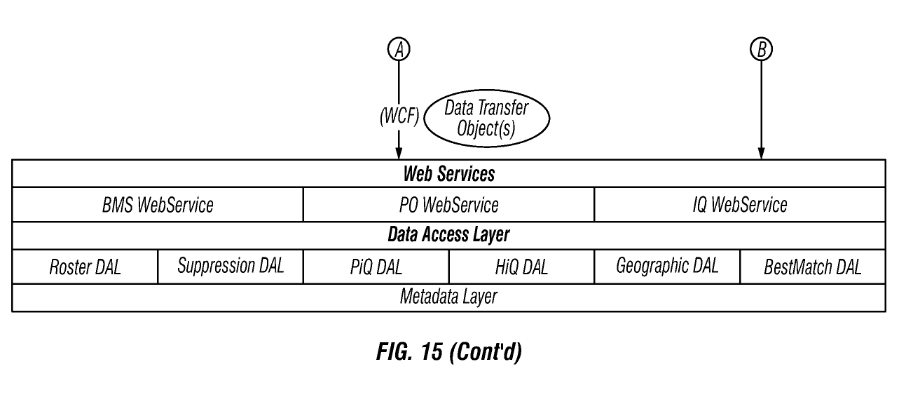

FIG. 15 is a schematic block diagram illustrating an example of a representative embodiment of a web application module for best match search. The web application module may provide the interface between the modules described in FIGS. 2-4 and the network 106 and/or the user interface device 108. The diagram illustrates the various web pages necessary to generate the graphical user interface 600, the comparison chart 800 and the detailed report 1000, and provides the detailed implementation of the present embodiments over the various network communication layers of the Internet 106.

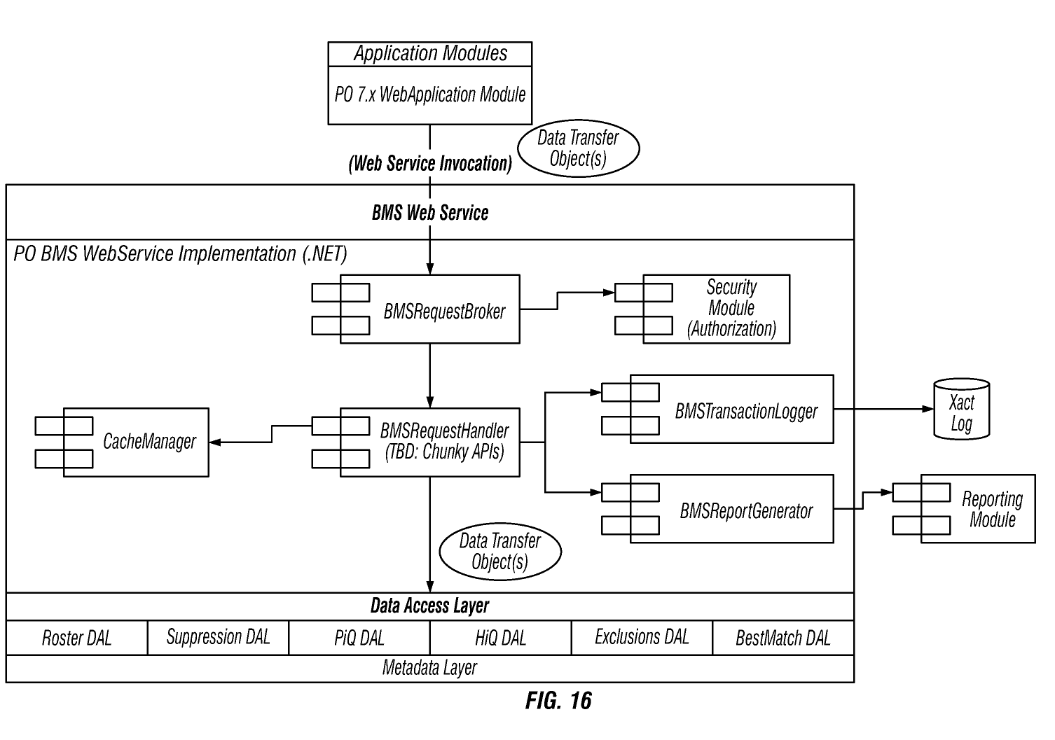

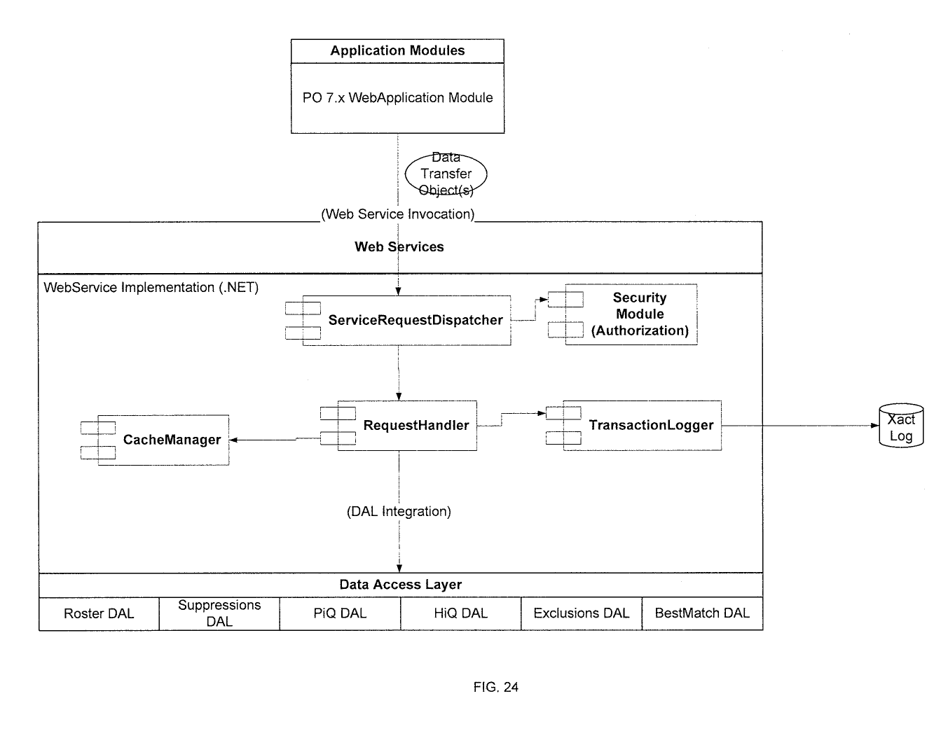

FIG. 16 is a schematic block diagram illustrating an example of a representative embodiment of a web service for best match search. The benefit of providing a web service for best match search is that other web developers may simply incorporate the web service as an object in their web designs. Thus the web application and functionality of the modules of FIGS. 2-4 becomes highly portable and easily implemented and distributed. FIG. 24 is a conceptual diagram illustrating an example of a representative embodiment of a method for providing a web service for best match search.

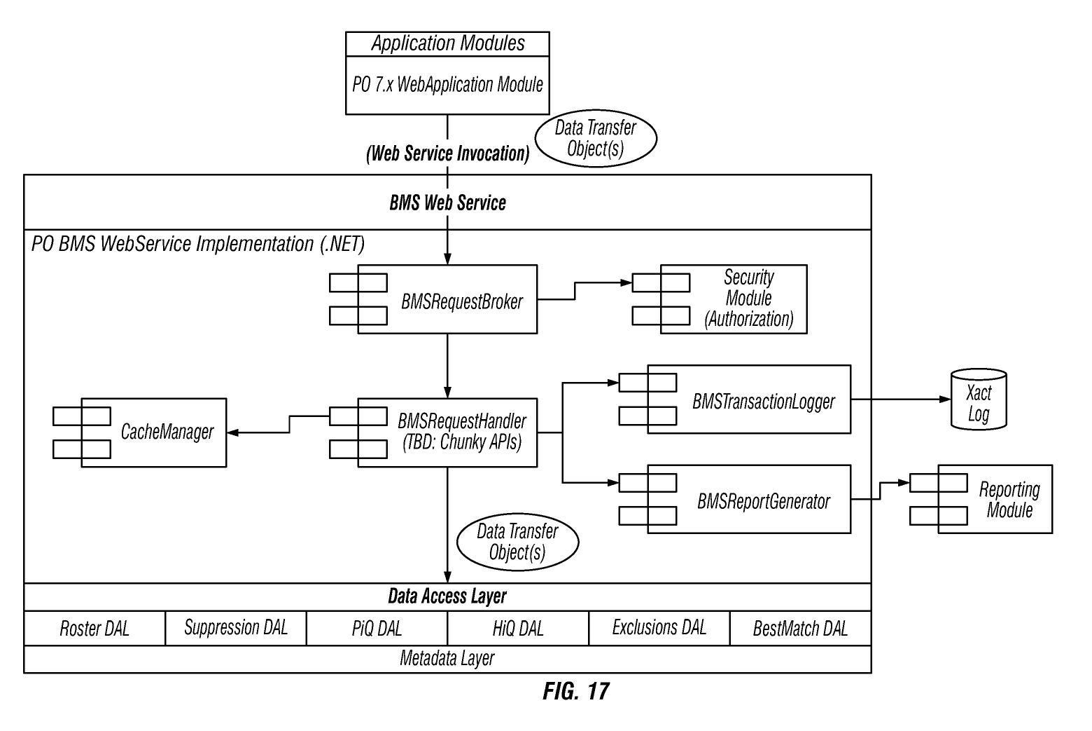

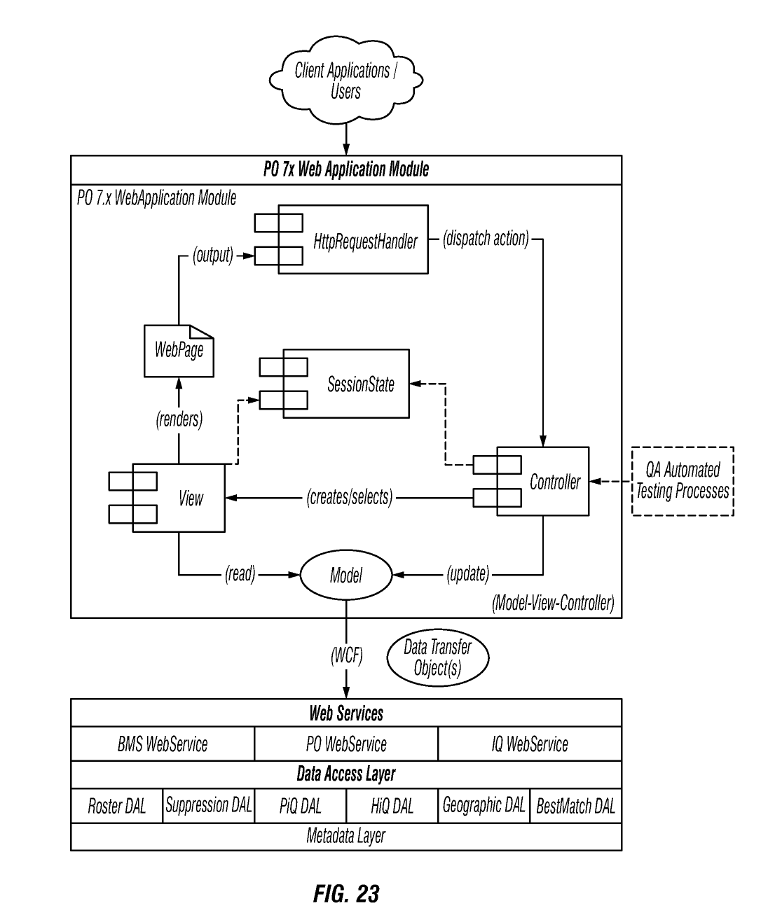

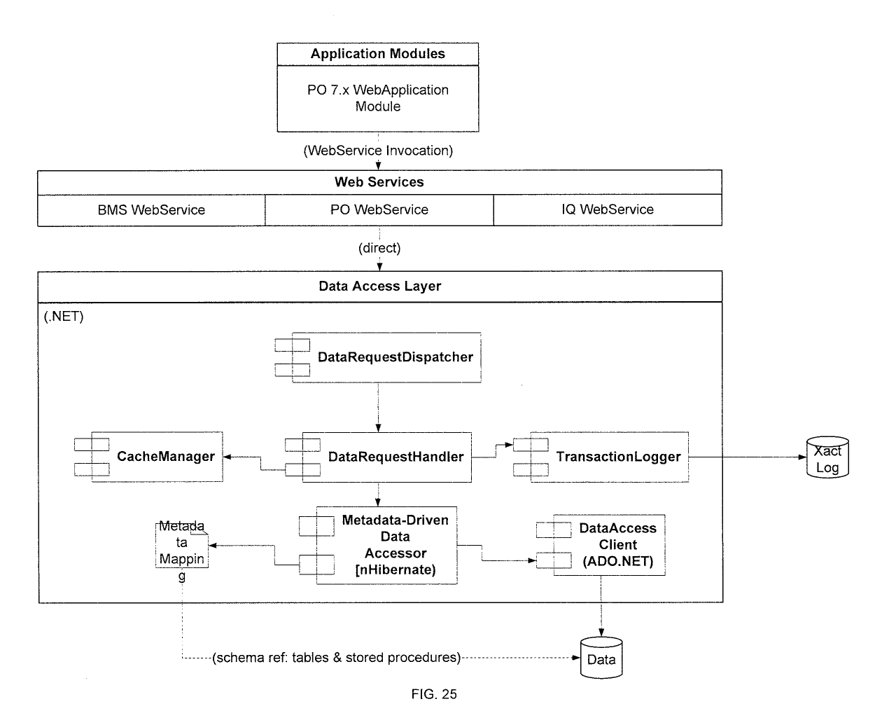

FIG. 17 is a schematic block diagram illustrating an example of a representative embodiment of an Internet accessible web application for best match search. This embodiment may be an alternative to providing a web service. In this embodiment, the server 102 may host the web application or may distribute the web application dynamically to run on the user interface device 108. FIG. 23 is a schematic block diagram illustrating an example of a representative embodiment of a system for providing a web based best match search application. This system may include the features and embodiments as described above. FIG. 25 is a conceptual diagram illustrating an example of a representative embodiment of a method for providing access to the web based application for best match search over the network 106.

FIGS. 18 and 20 are schematic flowchart diagrams illustrating examples of representative embodiments of methods for presenting a dynamically updating service provider counter. As the user enters user profile information and service provider criteria, the number of service providers that match the information entered may change. The counter may dynamically update as the information is added or changed.

FIGS. 19 and 21 are schematic flowchart diagrams illustrating examples of representative embodiments of methods for generating a list of service providers that match user profile information and/or service provider criterion. These method steps may be implemented using SQL or other database query languages.

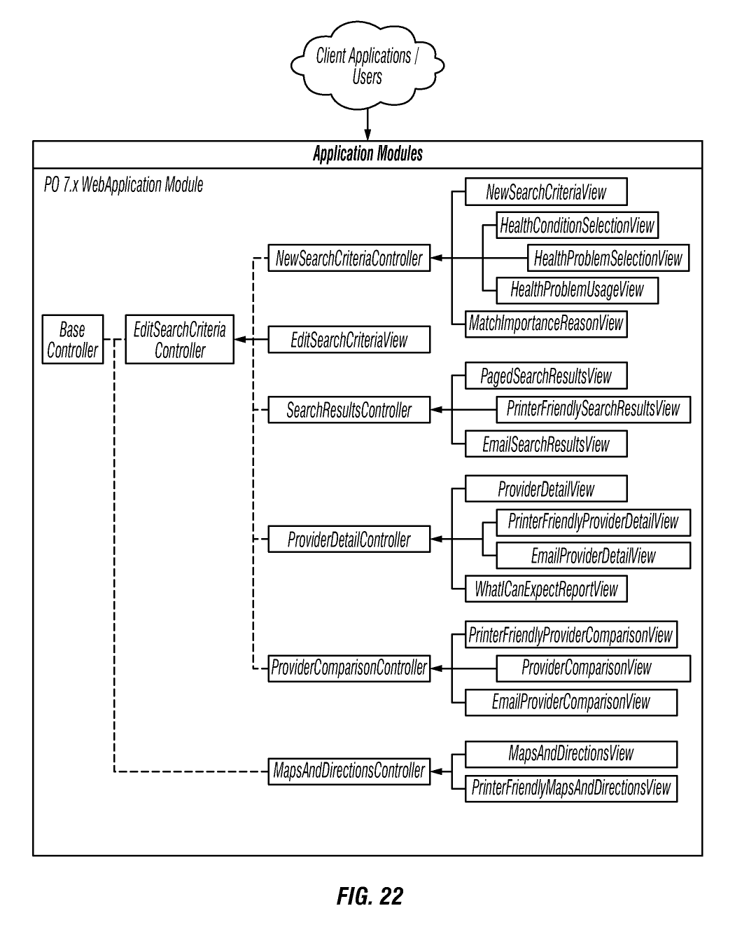

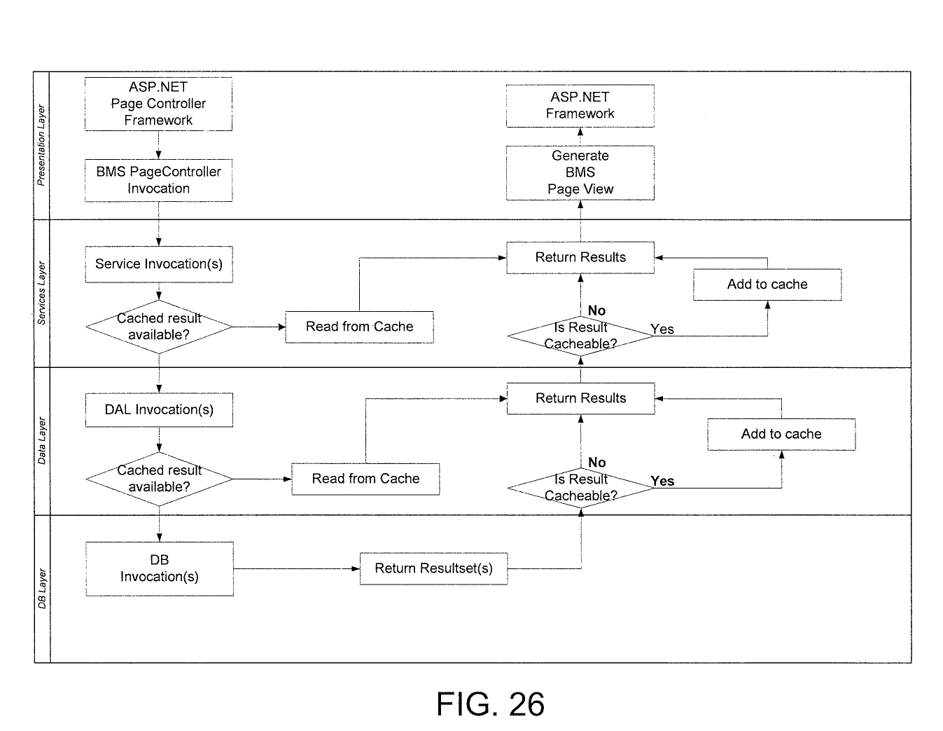

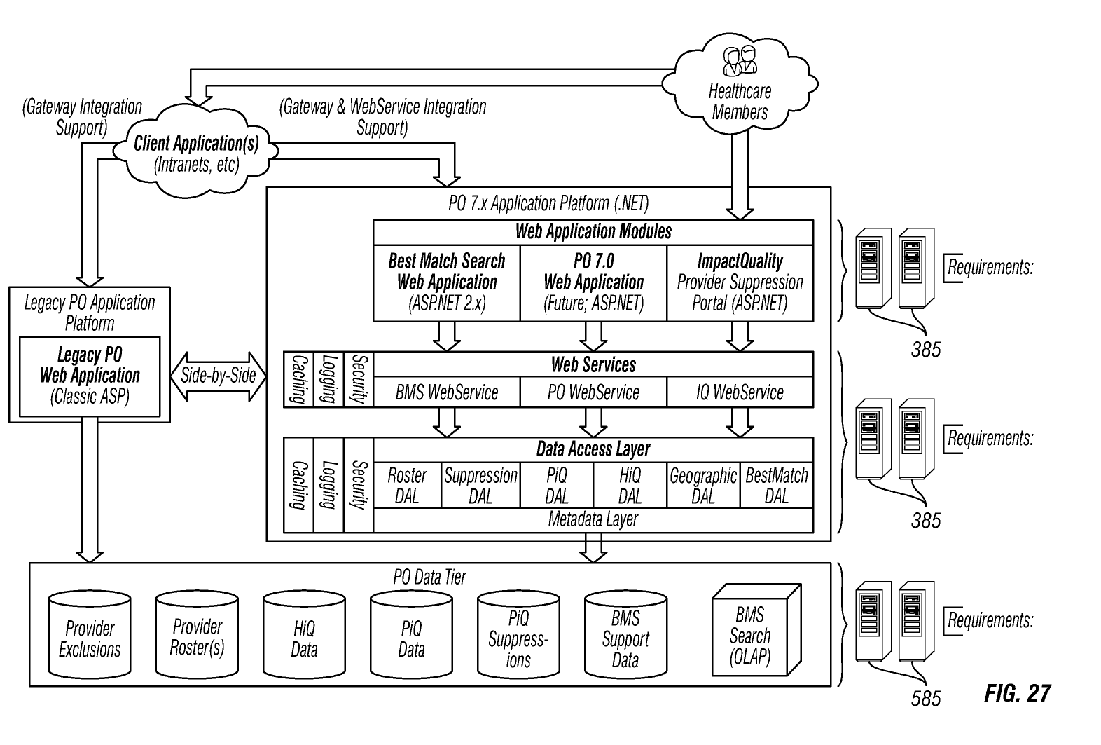

FIG. 22 is a schematic block diagram illustrating an example of a representative embodiment of an apparatus for best match search. The modules of this apparatus may provide substantially the same functionality as the modules described above with relation to FIGS. 2-4. In addition, these modules may enable a user to edit search criteria or user profile information, modify the view of the comparison chart 800 and the detailed report 1000, print any of the pages described in FIGS. 6-12, email content form the pages described in FIGS. 6-12, generate maps and driving directions to the service provider's office, and the like. FIG. 26 is a schematic flowchart diagram illustrating an example of transactions within a system for best match search. FIG. 27 is a schematic block diagram illustrating an example of a further embodiment of a tiered system for best match search.

### Example of a Representative Embodiment of Search Code for Best Match Search

The following search code may be implemented in SQL and may be used to perform various search functions described herein:

SET ANSI_NULLS ON
GO
SET QUOTED_IDENTIFIER ON
GO
CREATE TABLE [ProviderPEGAgeGenderPreEtg](

[ID] [bigint] IDENTITY(1,1) NOT NULL,
[IPDProviderID] [bigint] NOT NULL,
[PEGNumber] [smallint] NOT NULL,
[AgeBand] [tinyint] NULL,
[Gender] [char](1) NULL,
[PreETGNumber] [smallint] NULL,
[EpisodeCount] [int] NULL

) ON [PRIMARY]
GO
SET ANSI_NULLS ON
GO
SET QUOTED_IDENTIFIER ON
GO
CREATE TABLE [ProviderETGGender](

[ID] [bigint] IDENTITY(1,1) NOT NULL,
[IPDProviderID] [int] NULL,
[ETGNumber] [smallint] NULL,
[Gender] [char](1) NULL,
[EpisodeCount] [int] NULL,
[Score] [float] NULL,

PRIMARY KEY CLUSTERED
(

[ID] ASC

)WITH (IGNORE_DUP_KEY = OFF) ON [PRIMARY]
) ON [PRIMARY]

All of the methods disclosed and claimed herein can be made and executed without undue experimentation in light of the present disclosure. While the apparatus and methods of this invention have been described in terms of preferred embodiments, it will be apparent to those of skill in the art that variations may be applied to the methods and in the steps or in the sequence of steps of the method described herein without departing from the concept, spirit and scope of the invention. In addition, modifications may be made to the disclosed apparatus and components may be eliminated or substituted for the components described herein where the same or similar results would be achieved. All such similar substitutes and modifications apparent to those skilled in the art are deemed to be within the spirit, scope, and concept of the invention as defined by the appended claims.

1. An apparatus comprising:
a profile collection module configured to collect user profile information and a service provider criterion;
a profile match module in data communication with the profile collection module, the profile match module configured to match a service provider profile to at least one of the user profile information and the service provider criterion;
a provider analyzer in data communication with the profile match module, the provider analyzer configured to calculate a service provider statistic based on service provider data associated with a selected service provider; and
a provider comparison module in data communication with the provider analyzer, the provider comparison module configured to generate service provider comparison data in response to the service provider statistic.

2. The apparatus of claim 1, wherein the profile collection module further comprises a classifier collection module configured to collect a classifier to identify a specialty criterion for the service provider.

3. The apparatus of claim 1, wherein the profile collection module further comprises a user data collection module configured to collect the user profile information, wherein the user profile information comprises:
a type of service required;
a user characteristic;
a physical location of the user; and
a method of payment for the service.

4. The apparatus of claim 1, wherein the profile collection module further comprises a preference collection module configured to collect a preference identifier associated with one or more preferred characteristics in the service provider profile.

5. The apparatus of claim 1, wherein the profile match module further comprises a criterion summary module configured to generate a summary of the user profile information and the service profile criterion for display to the user.

6. The apparatus of claim 5, wherein the criterion summary module is configured to generate a summary of the patient profile information and the professional service profile criterion for display to the user.

7. The apparatus of claim 1, wherein the profile match module further comprises a match results module configured to generate a display comprising one or more matching service provider profiles, wherein the one or more matching service provider profiles are generated in response to a search of a service provider database based on at least one of the user profile information and the service provider criterion.

8. The apparatus of claim 1, wherein the profile match module further comprises a sort module configured to sort a plurality of service provider profiles in response to a user selected sort criterion.

9. The apparatus of claim 1, wherein the profile match module further comprises a filter module configured to filter a plurality of service provider profiles in response to a user selected filter criterion.

10. The apparatus of claim 1, wherein the provider analyzer further comprises a query module configured to query a database of service records to identify one or more service records associated with the selected service provider.

11. The apparatus of claim 10, wherein the service records further comprise medical insurance claim data associated with a claim for one or more medical services performed by a selected physician.

12. The apparatus of claim 10, wherein the provider analyzer further comprises a deidentifier module configured to remove personal information associated with a service record to ensure the privacy of a subject associated with the service record.

13. The apparatus of claim 10, wherein the provider analyzer further comprises a data processor configured to calculate the service provider statistic in response to data recorded in the one or more service records associated with the selected service provider.

14. The apparatus of claim 1, wherein the provider analyzer further comprises a provider scoring module configured to generate a score for the service provider in response to the service provider statistic, wherein the score is associated with a predetermined characteristics of the selected service provider.

15. The apparatus of claim 1, wherein the provider comparison module further comprises a provider selector configured to receive a user input associated with a selection of the service provider profile.

16. The apparatus of claim 1, wherein the provider comparison module further comprises a provider biography module configured to generate a biographical profile associated the selected service provider.

17. The apparatus of claim 1, wherein the provider comparison module further comprises a provider service statistic module configured to format a service provider comparison chart, the service provider comparison chart further comprising the service provider statistic.

18. The apparatus of claim 1, wherein the service provider statistic further comprises a service specific statistic associated with a selected service.

19. The apparatus of claim 1, wherein the service provider statistic further comprises a medication statistic associated with a record of a medication prescribed by a selected physician.

20. A system comprising:
a data storage device configured to store a plurality of service records associated with a plurality of service providers;
a server coupled to the data storage device, the server configured to:
collect user profile information and a service provider criterion;
match a service provider profile to at least one of the user profile information and the service provider criterion;
calculate a service provider statistic based on service provider data associated with a selected service provider; and
generate service provider comparison data in response to the service provider statistic; and
a network communication adapter coupled to the server, the network communication adapter configured to communicate with a remote user over a network.

21. A method comprising:
collecting user profile information and a service provider criterion;
matching a service provider profile to at least one of the user profile information and the service provider criterion;
calculating a service provider statistic based on service provider data associated with a selected service provider; and
generating service provider comparison data in response to the service provider statistic.

22. A computer readable medium comprising machine-readable instructions for:
collecting user profile information and a service provider criterion;
matching a service provider profile to at least one of the user profile information and the service provider criterion;
calculating a service provider statistic based on service provider data associated with a selected service provider; and
generating service provider comparison data in response to the service provider statistic.
